(19) United States
(12) Patent Application Publication
(10) Pub. No.: US 2018/0299080 A1
(43) Pub. Date: Oct. 18, 2018

(54) LED LAMP WITH COATED SUBSTRATE

(71) Applicant: GE LIGHTING SOLUTIONS, LLC, East Cleveland, OH (US)

(72) Inventors: Jon Bennett JANSMA, Pepper Pike, OH (US); Glenn Howard KUENZLER, Beachwood, OH (US); Jianmin HE, Orange, OH (US)

(21) Appl. No.: 15/486,415

(22) Filed: Apr. 13, 2017

(51) Int. Cl. F21K 9/237; F21K 9/232; F21V 3/02; F21K 9/90; F21V 9/16

(52) U.S. Cl. CPC F21K 9/237; F21K 9/232; F21Y 2115/10; F21K 9/90; F21V 9/16; F21V 3/02

(57) ABSTRACT

The present disclosure generally provides an LED lamp comprising a substrate, an LED light source in optical communication with the substrate, a diffusive coating applied to the substrate, and a luminescent coating disposed at least partially on the diffusive coating. The luminescent coating is between the LED light source and the diffusive coating. The luminescent coating has a composition selected to achieve a particular color temperature according to a characteristic of the LED light source. The present disclosure also generally provides a method of producing an LED lamp, comprising selecting a composition of a luminescent coating to achieve a particular color temperature according to a characteristic of an LED light source of the LED lamp, and coating a substrate in optical communication with the LED light source with a diffusive coating and the luminescent coating having the selected composition.

### FIELD

The disclosed exemplary embodiments relate generally to lighting systems, and more particularly to light emitting diode (LED) lighting systems.

### BACKGROUND

LED lighting technology continues to advance, resulting in improved efficiencies and lower costs. LED light sources are found in lighting applications ranging from small pin point sources to stadium lights. Thermal management, color control, and sufficient lumen output are some of the significant challenges that are typically considered when contemplating most retrofit LED lamp designs. In a typical LED lamp, a short wavelength LED producing blue or UV light may be coated with a yellow phosphor in order to produce white light. However, this technique may result in heating the LED by radiating light back onto the LED. In addition, the amount of heat generated by the LED may degrade the phosphor or prohibit the use of certain phosphors. Providing phosphors at a distance from an LED light source may significantly improve the thermal behavior and efficiency, however, this “remote” phosphor concept may suffer from poor product appearance because a color is often visible when the lamp is off.

LED chips, or LED chips coated with phosphor are typically binned according to output characteristics because of differences in LED chip efficiencies and variations in LED phosphor coatings. However, binning may be time consuming and expensive.

It would be desirable to provide an LED lamp design that addresses at least some of the problems identified above.

### SUMMARY

As described herein, the exemplary embodiments overcome one or more of the above or other disadvantages known in the art.

The aspects of the disclosed embodiments are directed to an LED lamp including a substrate, an LED light source in optical communication with the substrate, a diffusive coating applied to the substrate, and a luminescent coating disposed at least partially on the diffusive coating and between the LED light source and the diffusive coating. The luminescent coating has a composition selected to achieve a particular color temperature according to a characteristic of the LED light source.

The substrate may include a bulb shaped envelope within which the LED light source is mounted.

The substrate may include a cylindrically shaped envelope within which the LED light source is mounted.

The LED light source may include one or more surface mount chips.

The LED light source may include an LED filament arrangement.

The diffusive coating may be configured to obscure a color of the luminescent coating.

The characteristic of the LED light source may be an output wavelength.

The characteristic of the LED light source may be a color temperature.

The diffusive and luminescent coatings may be applied to an interior surface of the substrate proximate the LED light source.

The diffusive and luminescent coatings may be applied to an outside surface of the substrate distal from the LED light source.

The diffusive coating may include a shatter resistant coating.

The aspects of the disclosed embodiments are also directed to a method of producing an LED lamp, including selecting a composition of a luminescent coating to achieve a particular color temperature according to a characteristic of an LED light source of the LED lamp, and coating a substrate in optical communication with the LED light source with a diffusive coating and the luminescent coating having the selected composition, with the luminescent coating having the selected composition disposed at least partially on the diffusive coating.

The substrate may include a bulb shaped envelope within which the LED light source is mounted.

The substrate may include a cylindrically shaped envelope within which the LED light source is mounted.

The LED light source may include one or more surface mount chips.

The LED light source may include an LED filament arrangement.

The method of producing the LED lamp may include configuring the diffusive coating to obscure a color of the luminescent coating.

The method of producing the LED lamp may include selecting the composition of the luminescent coating to achieve a particular color temperature according to an output wavelength of the LED light source.

The method of producing the LED lamp may include selecting the composition of the luminescent coating to achieve a particular color temperature according to a color temperature of the LED light source.

The method of producing the LED lamp may include applying the diffusive and luminescent coatings to an interior surface of the substrate proximate the LED light source.

The method of producing the LED lamp may include applying the diffusive and luminescent coatings to an outside surface of the substrate distal from the LED light source.

The method of producing the LED lamp may include formulating the diffusive coating as a shatter resistant coating.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIGS. 1-4 show exemplary LED lamps incorporating aspects of the disclosed embodiments.

### DETAILED DESCRIPTION OF THE DISCLOSED EMBODIMENTS

As described herein, the exemplary embodiments overcome one or more of the above or other disadvantages known in the art.

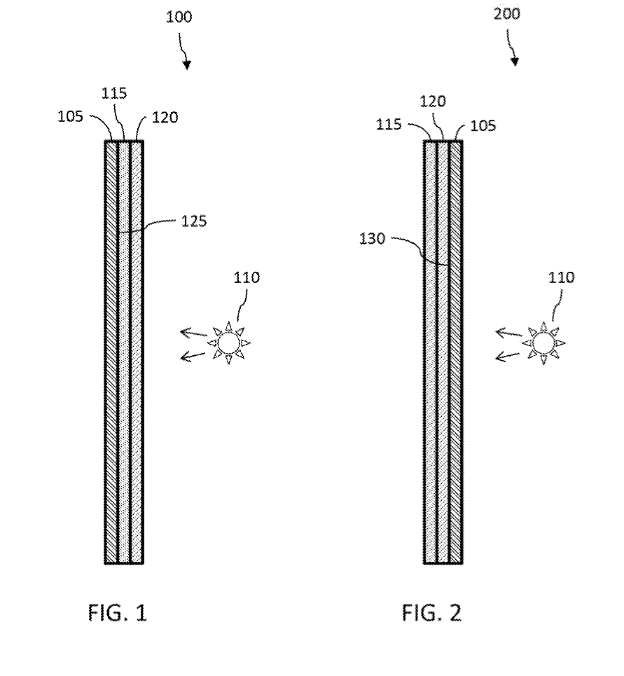

FIG. 1 illustrates a schematic diagram of an exemplary LED lamp structure 100 incorporating to the disclosed embodiments. The LED lamp structure 100 includes a substrate 105, an LED light source 110, a diffusive coating 115, and a luminescent coating 120 disposed at least partially on the diffusive coating 115 and between the LED light source 110 and the diffusive coating 115.

The substrate may comprise one or more of glass, polymers, plastic, translucent ceramic, or other suitable material for accepting a coating and for transmitting light.

The LED light source may include one or more blue, UV, or coated LEDs, for example, coated LEDs having specific color temperatures. The one or more LEDs may be embodied as surface mount devices, devices with axial or radial leads, or may be configured together linked in a filament arrangement. In some embodiments, the LED light source may include one or more LEDs with a resulting color temperature of approximately 5000K-10000K.

The diffusive coating 115 may include frosting, texturing, a light diffusing coating, an electrostatic diffusive coating, embedded light scattering particles, or other material or treatment for providing both diffuse transmission and reflection of light. The luminescent coating 120 interposed between the LED light source 110 and the diffusive coating 115 may include a phosphor coating, for example, one or more of organic phosphors, specialty LED phosphors such as PFS red phosphor, high performance Nitride type red phosphors such as Europium doped nitride type red phosphors, and Neodymium based filter materials. Other exemplary luminescent coatings 120 may include one or more of potassium fluorosilicate (PFS)-based phosphors such as K2SiF6:Mn, NdF3, Nd2O3, and NdFO coatings, for example, those including Nd, fluorine and oxygen such as a neodymium oxyfluoride. A composition of the luminescent coating 120 may be selected according to the characteristics of the LED light source to achieve a particular color temperature of light as a result of the light passing through the luminescent coating 120 and the diffusive coating 115. For example, a phosphor or combination of phosphors may be selected for the luminescent coating to achieve a specific color temperature, based on a frequency of blue or UV light emitted by the one or more LEDs. In another example, a composition of the luminescent coating 120 may be selected to achieve a specific color temperature, based on a color temperature of one or more coated LEDs.

In operation, light is emitted from the LED light source 110 and may be converted to white light as the emitted light passes through the luminescent coating 120. The LED light source may emit a blue, UV, or other type of light, for example, light having a specific color temperature. The selected composition of the luminescent coating 120 operates to perform the conversion to a particular color temperature.

A much broader range of phosphor, pigment, or notch filter material types may be used in the luminescent coating 120 when the luminescent coating 1120 is remote from the LED light source 110, at least due to lower temperatures relative to those on or proximate the LED light source 110. The luminescent coating 120 may comprise one or more of organic phosphors, for example, specially phosphors such as PFS red phosphor, high performance Nitride type red phosphors such as Europium doped nitride type red phosphors, and Neodymium based filter materials. Other exemplary luminescent coatings 120 may include one or more of potassium fluorosilicate (PFS)-based phosphors such as K2SiF6:Mn, NdF3, Nd2O3, and NdFO coatings, for example, those including Nd, fluorine and oxygen such as a neodymium oxyfluoride.

Furthermore, the diffusive coating 115 may at least partially shield the luminescent coating 120 from view. In some embodiments the diffusive coating 115 may provide the substrate 105 and luminescent coating 120 with a translucent white appearance rather than a colored appearance that may be typical of the luminescent coating 120. For example, a luminescent coating 120 with LED phosphors such as Y3Al5O12:Ce3+ may have a yellow appearance which the diffusive coating 115 may operate to conceal.

The embodiment of FIG. 1 shows the diffusive 115 and luminescent 120 coatings as applied to an interior surface 125 of the substrate 105 proximate the LED light source 110.

FIG. 2 illustrates a schematic diagram of an exemplary LED lamp structure 200 where the diffusive coating 115 and the luminescent coating 120 may be applied to an exterior surface 130 of the substrate 105 distal to the LED light source 110. For example, the luminescent coating 120 may be applied to the exterior surface 130 and the diffusive coating 115 may be applied over the luminescent coating 120.

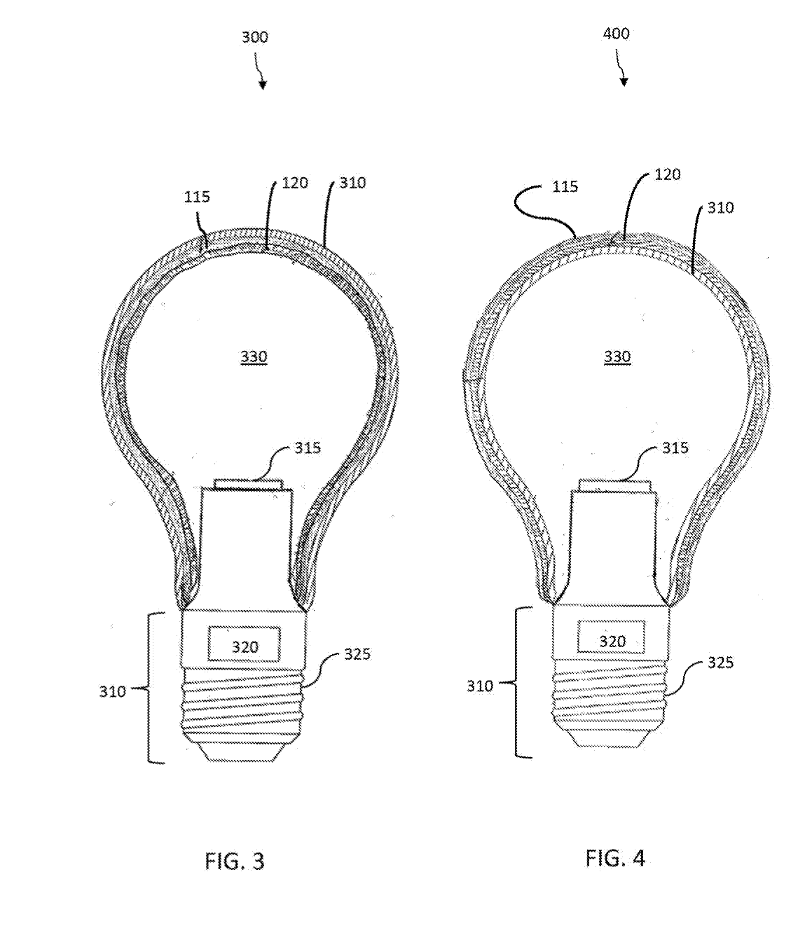

FIG. 3 shows an embodiment where the where the diffusive coating 115 and the luminescent coating 120 may be applied to an interior surface of a bulb shaped envelope 305 of an LED lamp 300, for example, an A type lamp. The LED lamp 300 includes a base 310, an LED light source 315, typically mounted on an extension of the base 310, and a power supply 320, typically housed within the base 310. The base may include a base connector 325 with electrical contacts for supplying electrical power from a mains supply to power supply 320. While an E type base connector is illustrated, it should be understood that the disclosed embodiments may include any style connector, bayonet, screw, single or double contact, or mogul connector, or any base connector suitable for use with the disclosed embodiments.

Envelope 305 may generally enclose the LED light source 315. In at least one aspect, the envelope 310 may be hermetically sealed and may confine a cooling medium 330 or fluid, for example, an inert, low atomic mass cooling gas such as He or H2, to improve heat flow within the envelope 310. The cooling medium 330 may also provide a moisture free environment within the envelope 310 and may prevent atmospheric reactions with water, oxygen, CO2, or other materials from occurring over time. The cooling medium 330 may have a pressure of from about 10 torr (mm Hg) to less than about 1 atm. Effective heat transport may occur at pressures as low as approximately 50 Torr; however any suitable fluid pressure may be utilized. Heat generated by the LED light source 315 may be dissipated through one or more of conduction, convection, and emission, and in combination with the cooling medium may eliminate any need for a heat sink.

In some embodiments, the envelope 310 may be constructed of glass. Other embodiments may utilize one or more of glass, plastic, translucent ceramic, or other suitable material for transmitting light and for confining the cooling medium within the envelope 310.

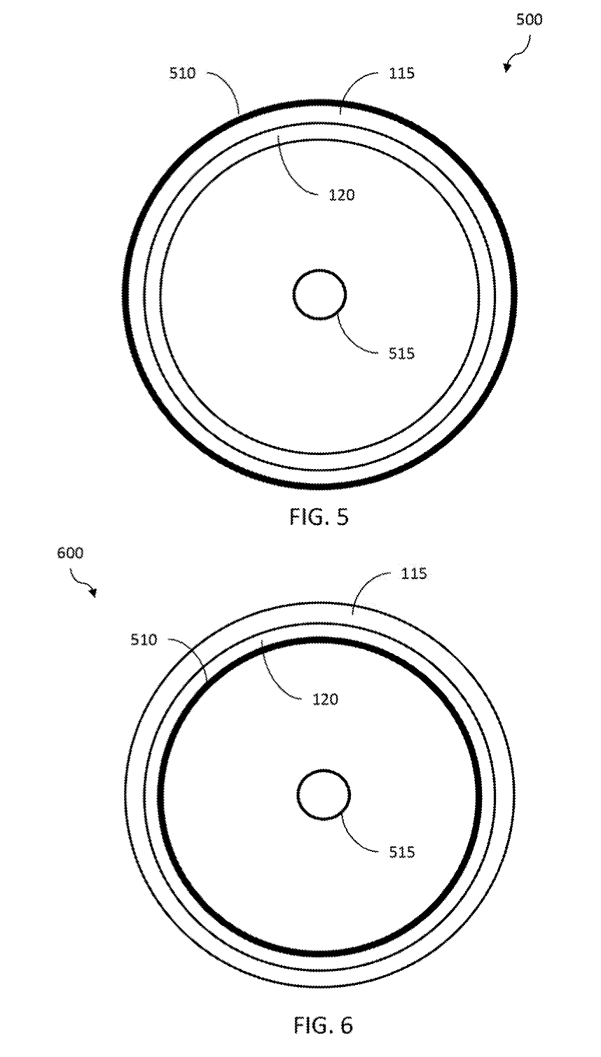

FIG. 4 shows an embodiment where the where the diffusive coating 115 and the luminescent coating 120 are applied to an outer surface of the envelope 310. In this embodiment, the luminescent coating 120 may be applied to an outer surface of the envelope 310 and the diffusive coating 115 may be applied over the luminescent coating. In some embodiments, the diffusive coating 115 and the luminescent coating 120 may be incorporated into a protective, safety, or shatter resistant coating to minimize the fragility of the envelope 310 and to contain fragments of the envelope 310 in the event the envelope 310 is broken.

FIGS. 5 and 6 show embodiments 500, 600 where the where the diffusive coating 115 and the luminescent coating 120 may be applied to a surface of a cylindrical envelope 510 of an LED lamp, for example, a T type lamp. In these embodiments, the cylindrical envelope 510 generally surrounds a linear arrangement of LED light sources 515. In FIG. 5, the diffusive coating 115 may be applied to an inner surface of the cylindrical envelope 510, and the luminescent coating 120 may be applied to the diffusive coating 115, interposed between the diffusive coating 115 and the LED light sources 515. In the embodiment shown in FIG. 6, the luminescent coating 115 is applied to an outer surface of the envelope 10 and the diffusive coating 115 is applied over the luminescent coating 155.

As described above, light is emitted from the LED light source 110, 315, 515 and may be converted to white light as the emitted light passes through the luminescent coating 120. The LED light source may emit a blue, UV, or other type of light, for example, light having a specific color temperature, and in some embodiments, the LED light source may emit a color temperature of approximately from 5000K-10000K. A particular color temperature of light, as a result of passing through the luminescent coating, may be achieved by selecting a particular composition of the luminescent coating 120.

Also as described above, the diffusive coating 115 may at least partially shield the luminescent coating 120 from view and may provide the substrate 105 and luminescent coating 120 with a translucent white appearance rather than a colored appearance that may be typical of the luminescent coating 120.

While the disclosed embodiments are shown utilizing A and T type envelopes, it should be understood that the disclosed embodiments may include AR, B, BR, C, E, ER, G, K, MB, MR, PAR, R, S, or any suitable envelope shape.

Conventional coating methods can be employed to apply the diffusive and luminescent coatings which may utilize automated manufacturing equipment. For example, present fluorescent and incandescent lamp manufacturing equipment and processes, including existing glass bulb manufacturing facilities and methods, may be utilized for manufacturing the disclosed LED lamps. This may result in decreased development of production techniques and reduced on-going production costs.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. An LED lamp comprising:
a substrate;
an LED light source in optical communication with the substrate;
a diffusive coating applied to the substrate; and
a luminescent coating disposed at least partially on the diffusive coating and between the LED light source and the diffusive coating; the luminescent coating having a composition selected to achieve a particular color temperature according to a characteristic of the LED light source.

2. The LED lamp of claim 1, wherein the substrate comprises a bulb shaped envelope within which the LED light source is mounted.

3. The LED lamp of claim 1, wherein the substrate comprises a cylindrically shaped envelope within which the LED light source is mounted.

4. The LED lamp of claim 1, wherein the LED light source comprises one or more surface mount chips.

5. The LED lamp of claim 1, wherein the LED light source comprises an LED filament arrangement.

6. The LED lamp of claim 1, wherein the diffusive coating is configured to obscure a color of the luminescent coating.

7. The LED lamp of claim 1, wherein the characteristic of the LED light source is an output wavelength.

8. The LED lamp of claim 1, wherein the characteristic of the LED light source is a color temperature.

9. The LED lamp of claim 1, wherein the diffusive and luminescent coatings are applied to an interior surface of the substrate proximate the LED light source.

10. The LED lamp of claim 1, wherein the diffusive and luminescent coatings are applied to an exterior surface of the substrate distal from the LED light source.

11. The LED lamp of claim 1, wherein the diffusive coating comprises a shatter resistant coating.

12. A method of producing an LED lamp, comprising:
selecting a composition of a luminescent coating to achieve a particular color temperature according to a characteristic of an LED light source of the LED lamp; and
coating a substrate in optical communication with the LED light source with a diffusive coating and the luminescent coating having the selected composition, with the luminescent coating having the selected composition disposed at least partially on the diffusive coating.

13. The method of claim 12, wherein the substrate comprises a bulb shaped envelope within which the LED light source is mounted.

14. The method of claim 12, wherein the substrate comprises a cylindrically shaped envelope within which the LED light source is mounted.

15. The method of claim 12, wherein the LED light source comprises one or more surface mount chips.

16. The method of claim 12, wherein the LED light source comprises an LED filament arrangement.

17. The method of claim 12, comprising configuring the diffusive coating to obscure a color of the luminescent coating.

18. The method of claim 12, comprising selecting the composition of the luminescent coating to achieve a particular color temperature according to an output wavelength of the LED light source.

19. The method of claim 12, comprising selecting the composition of the luminescent coating to achieve a particular color temperature according to a color temperature of the LED light source.

20. The method of claim 12, comprising applying the diffusive and luminescent coatings to an interior surface of the substrate proximate the LED light source.

21. The method of claim 12, comprising applying the diffusive and luminescent coatings to an outside surface of the substrate distal from the LED light source.

22. The method of claim 12, comprising formulating the diffusive coating as a shatter resistant coating.
